(19) United States
(12) Patent Application Publication
(10) Pub. No.: US 2017/0356418 A1
(43) Pub. Date: Dec. 14, 2017

(54) Piston Type Expander

(71) Applicant: EXOES, Gradignan (FR)

(72) Inventors: Remi DACCORD, Villenave D'Ornon (FR); Thiebaut KIENTZ, Paris (FR)

(21) Appl. No.: 15/177,153

(22) Filed: Jun. 8, 2016

(51) Int. Cl. F03C 1/02; F04B 39/04

(52) U.S. Cl. CPC F03C 1/02; F04B 39/04

(57) ABSTRACT

The invention relates to a piston type expander (4) comprising:
an intake cylinder head for a working fluid in the gaseous state under pressure comprising an intake opening (40) for said working fluid,
an expansion zone connected to the intake cylinder head and comprising a plurality of cylinders, wherein a piston sliding in each respective cylinder is connected to a shaft (42) by a mechanical connection, each cylinder comprising at least one exhaust port (12) through which the expanded working fluid in the gaseous state can be discharged from the expansion zone,
a crankcase (17) designed to contain a lubricant in the liquid state, wherein is positioned said mechanical connection,
a cavity provided in the expander (4), connected to said exhaust ports, leading to an exhaust opening (41) of the expander for the expanded working fluid in the gaseous state, said cavity being designed to guide a flow of the expanded working fluid bearing a fraction of lubricant in the liquid state, said cavity (43) having a common wall with the crankcase (17) and being designed to favor the separation of the liquid lubricant fraction from the expanded working fluid in the gaseous state.

### FIELD OF THE INVENTION

The present invention relates to a piston type expander, a system for converting thermal energy comprising such a machine and a method for separating a lubricant fraction in the liquid state from a working fluid in the gaseous state in such an expander.

### BACKGROUND OF THE INVENTION

Systems for converting heat coming from an engine into mechanical energy are known. Such assemblies are known in particular for the conversion of heat emitted by internal combustion engines, which is dissipated in particular during the expulsion of exhaust gases and is thus lost.

Such assemblies are subjected to demanding weight and size constraints. They thus tend to become more and more compact.

These systems operate with a working fluid which is subjected to a thermodynamic Rankine cycle comprising compression, evaporation supplemented possibly by superheat, expansion in an expander and condensation. Expansion in the expander makes it possible to operate movable members such as pistons so as to obtain mechanical energy.

As these expanders comprise movable parts, they conventionally require the use of a lubricant at the mechanical connections between the movable parts, such as bearings or more generally contact surfaces.

Of particular interest are systems comprising an expander which comprises an intake cylinder head for a pressurized working fluid in the gaseous state, an expansion zone comprising a plurality of cylinders, wherein a piston sliding in each respective cylinder is connected to a shaft by a mechanical connection, a crankcase containing a lubricant in the liquid state, in which is positioned said mechanical connection.

The working fluid circulates in a primary circuit, and the lubricant, for its part, is confined to the crankcase.

One problem resulting from this structure is connected to the possible migration of working fluid toward the crankcase and, conversely, of the lubricant toward the primary circuit.

Indeed, the presence of working fluid in the lubricated areas within the crankcase causes deterioration in the quality of lubrication. The working fluid can thus condense and dilute the lubricant, the viscosity and lubricating properties whereof would be affected.

Moreover, lubricant leakage toward the primary circuit causes several adverse effects.

First, the quantity of the lubricant at the mechanical connections is reduced, which can cause wear and deterioration of the movable parts.

Moreover, lubricants used conventionally are not suited to be exposed to elevated temperatures such as those to which the working fluid is exposed, the exhaust gases of a Diesel vehicle for example being able to attain a temperature of the order of 500° C. The temperature at certain points in the primary circuit can thus have elevated temperatures, for example of the order of 250° C. The lubricant is then likely to decompose and could thus be lacking in the expander. Its decomposition can also cause the formation of chemical compounds harmful to the system. Frequent maintenance will be the result.

Finally, a considerable quantity of oil in circulation in the primary circuit will deteriorate heat-exchange performance at the heat exchangers (evaporator and condenser) and will increase head losses in the circuit.

Increasing requirements regarding compactness bring about a reduction in the areas separating the working fluid from the lubricant, which increases these problems.

The proportion of lubricant in the primary circuit is defined by the OCR (acronym of “Oil Circulation Rate”).

To reduce the OCR, it is known to install a separator at the exhaust of the expander, with the aim of recovering, at the exhaust of this expander, the liquid portion contained in the working fluid, this liquid portion being primarily lubricant.

However, such a separator penalizes the compactness of the system. Moreover, such a separator is costly.

### BRIEF DESCRIPTION OF THE INVENTION

One aim of the invention is to design an expander which makes it possible to reduce the OCR.

In conformity with the invention, a piston type expander is proposed which comprises:
an intake cylinder head for a working fluid in the gaseous state under pressure comprising an intake opening for said working fluid.
an expansion zone connected to the intake cylinder head and comprising a plurality of cylinders, wherein a piston sliding in each respective cylinder is linked to a shaft by a mechanical connection, each cylinder comprising at least one exhaust port through which the expanded working fluid in the gaseous state can be exhausted from the expansion zone,
a crankcase designed to contain a lubricant in the liquid state, in which is positioned said mechanical connection,
a cavity provided in the expander, connected to said exhaust ports, leading to an exhaust opening of the expander for the expanded working fluid in the gaseous state, said cavity being designed to guide a flow of the expanded working fluid bearing a fraction of lubricant in the liquid state, said cavity having a common wall with the crankcase.

Said cavity favors the separation of the liquid lubricant fraction from the expanded working fluid in the gaseous state.

In the present text, the terms “upper portion,” “above” or “high point” and conversely “lower portion,” “below” or “low point” must be understood relative to the normal utilization position of the expander.

The term “length of the expander” is understood to be the dimension parallel to the shaft connected to the pistons.

Particularly advantageously, the cavity comprises mechanical means for separating the lubricant in the liquid state from the working fluid in the gaseous state. Said separation means can comprise at least: one system designed to cause rotation and/or turbulence in the flow, a coalescer, a deflector and/or a baffle.

According to one embodiment, said mechanical separation means comprise a coalescer forming an integral part of the cavity.

Particularly advantageously, the cavity is further formed so as to slow down the flow of the expanded working fluid in the gaseous state.

According to one embodiment, the cavity is divided longitudinally into two distinct chambers.

Moreover, the cavity can advantageously comprise means for cooling the common wall with the crankcase. Said cooling means can comprise fins extending into the cavity from the common wall with the crankcase.

According to one embodiment, said expander is axial, the mechanical connection between each piston and the shaft comprising an inclined plate, each piston being parallel to said shaft.

According to one embodiment of this axial expander, the pistons are double-acting, the expander comprises two expansion zones on either side of the expander and a single exhaust opening for the expanded working fluid and the cavity is connected to the exhaust ports of the two expansion zones and to the exhaust opening.

According to another embodiment of the axial expander, the pistons are double-acting, the expander comprises two expansion zones on either side of the expander and two exhaust openings for the expanded working fluid, and the cavity is divided longitudinally into two distinct chambers, each chamber being connected to both expansion zones and to an exhaust opening.

According to another embodiment of the axial expander, the pistons are double-acting, the expander comprises two expansion zones on either side of the expander and two exhaust openings for the expanded working fluid, and each chamber is connected to the exhaust ports of a respective expansion zone and to the exhaust opening opposite to said expansion zone.

Preferably, the pistons are crosshead pistons, each crosshead being guided by a guide provided in a wall of the crankcase forming a partition between the exhaust zone and the crankcase.

Preferably, the cavity comprises at least one opening designed to allow return of the lubricant in the liquid state to the crankcase.

Moreover, the crankcase advantageously comprises an evacuation opening for the working fluid in the gaseous state toward the exhaust opening.

Another object relates to a system for converting thermal energy coming from a combustion engine, comprising an expander as described above, and a single device for separating lubricant from the working fluid, said device being positioned in the cavity of the expander.

Another object relates to a method for separating a fraction of lubricant in the liquid state from a working fluid in the gaseous state in a piston type expander, comprising:
intake of the working fluid in the gaseous state under pressure in an intake cylinder head through an intake opening,
expansion of said working fluid in the gaseous state in an expansion zone connected to the intake cylinder head and comprising a plurality of cylinders, wherein a piston sliding in each respective cylinder is connected to a shaft by a mechanical connection lubricated by the lubricant in the liquid state,
discharge of the expanded working fluid in the gaseous state through at least one exhaust port provided in each cylinder,
flow, in a cavity provided in the expander connected to said exhaust ports and leading to an exhaust opening of the expander for the expanded working fluid in the gaseous state, of a flow of the expanded working fluid bearing a fraction of lubricant in the liquid state, and separation, in said cavity, of the liquid lubricant fraction from the expanded working fluid in the gaseous state.

### BRIEF DESCRIPTION OF THE DRAWINGS

Other features and advantages of the invention will be revealed by the detailed description which follows, with reference to the appended drawings wherein:

FIG. 1 is a schematic diagram of a Rankine circuit,

FIG. 2 is a perspective view of the outside of an axial expander according to an embodiment of the invention,

FIG. 3 is a longitudinal section view of the inside of the axial expander of FIG. 2,

FIG. 4 is a transverse section view of the separation cavities provided in said axial expander,

FIGS. 5A and 5B are perspective views of the outside of an axial expander with double-acting pistons according to two variant embodiments of the invention,

FIGS. 6A and 6B are perspective views of the outside of an axial expander with single-acting pistons according to two variant embodiments of the invention,

FIGS. 7A and 7B are respectively a transverse section view and a longitudinal section view of an expander having an architecture with two in-line cylinders.

### DETAILED DESCRIPTION OF THE INVENTION

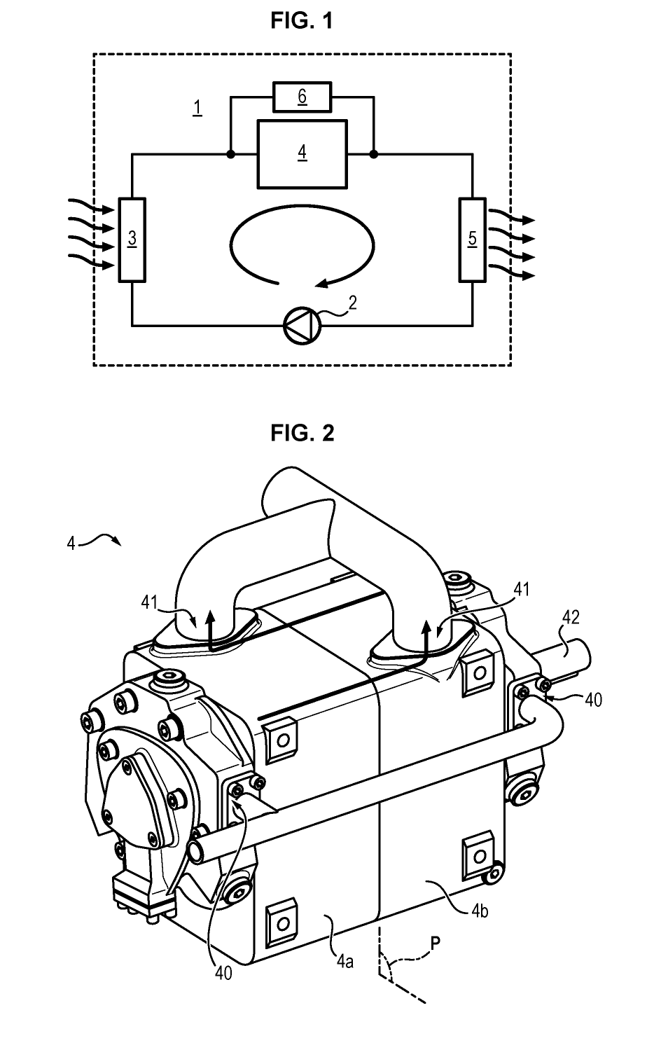

FIG. 1 shows a circuit implementing a Rankine thermodynamic cycle.

Shown in this figure is a circuit 1 containing a working fluid, the circuit 1 comprising:
a pump 2, typically a pump designed to deliver a flow of working fluid which establishes a pressure of 40 bars on its discharge;
a first heat exchanger 3 which is called hereafter an “evaporator;”
an expander 4;
a second heat exchanger 5, which will hereafter be called a “condenser;”
a bypass device 6.

The pump 2 supplies the evaporator 3 with working fluid in the liquid state under pressure, typically on the order of 40 bars.

The evaporator 3 is located in a medium with elevated temperatures, and thus accomplishes heat transfer between this high-temperature medium and the working fluid so that the latter is evaporated and passes into the gaseous state.

The working fluid leaving the evaporator 3 is therefore in the gaseous state and under pressure.

The working fluid then passes through the expander 4, wherein expansion occurs.

The expansion of the working fluid in the expander 4 involves movable means such as a rotating mechanical shaft, thus allowing the energy of the working fluid to be recovered.

The movable means are advantageously coupled to the shaft of the internal combustion engine, so as to re-inject a mechanical torque. The movable means can also be coupled to energy conversion means such as an electric generator, so as to allow conversion of the energy resulting from the expansion into electrical energy.

The working fluid leaving the expander 4 is therefore in the gaseous state and at a low pressure, typically on the order of 2.2 bars.

The working fluid then passes through the condenser 5, which is located in a medium having a low temperature so as to accomplish heat exchange between the working fluid and this low-temperature medium to reduce the working fluid temperature, and bring it back to the liquid state.

The working fluid leaving the condenser 5 is therefore in the liquid state and at low pressure, on the order of 2.2 bars. It is then re-injected into the circuit 1 by the pump 2 and repeats the cycle previously described.

The circuit 1 shown further comprises a bypass device 6 designed to make it possible to take all or a portion of the working fluid upstream of the expander 4 and re-inject it into the circuit 1 downstream of the expander 4, thus functioning as a short-circuit of the expander 4. Such a device is often called a “bypass.”

Such a bypass device 6 is advantageously used in the initiation phase of the circuit 1 so as to allow the establishment of conditions of temperature and pressure in the circuit 1 and/or so as to achieve a temperature rise in the crankcase 17, or in the event of needing to modulate the operation of the circuit 1.

FIG. 2 shows a perspective view of the expander 4 (also called “machine” in the following description).

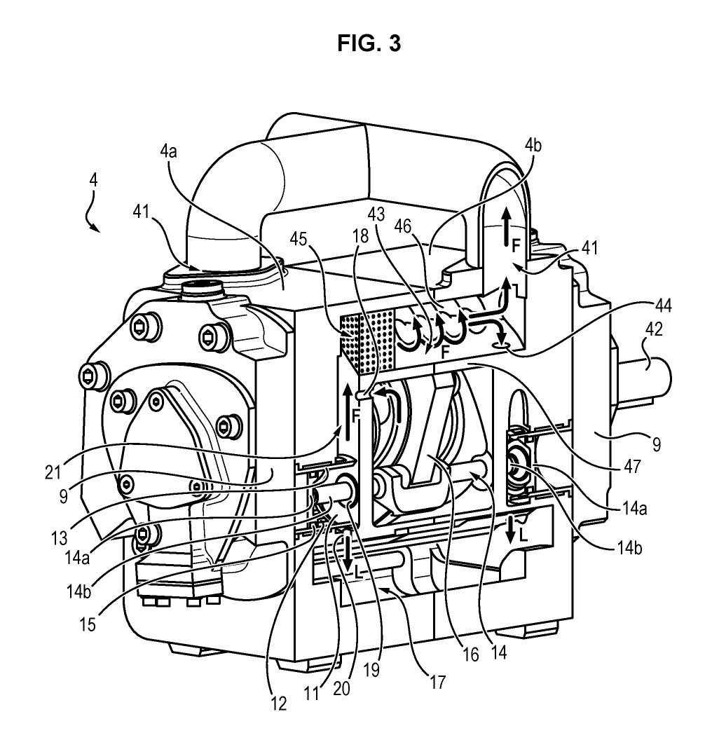

In FIGS. 2 to 3, the expander is an axial expander comprising double-acting pistons, i.e. working on both sides, driving a shaft 42. In this non-limiting example, the expander comprises two intake openings 40 for working fluid in the gaseous state under pressure, located at two opposite ends of the machine, and two exhaust openings 41 for the expanded working fluid in the gaseous state, which are located on a high point of the machine.

The invention also applies, however, to an axial expander comprising single-acting pistons and there having in this case one intake opening for working fluid in the gaseous state under pressure and one or two exhaust openings for the expanded working fluid in the gaseous state.

The invention is however not limited to axial expanders but is applied more generally to any expander comprising pistons sliding in cylinders and connected to a shaft by a lubricated mechanical connection, for example an expander having an architecture with two in-line cylinders.

In general, all the pistons are connected to the same shaft.

FIG. 3 shows an example of structure of the axial expander 4.

The working fluid at elevated pressure is brought into a cylinder head 9 of the expander 4, the interior structure whereof has not been shown, through each intake opening 40, then passes through an intake device to reach an expansion zone 11. This expansion zone 11 comprises a cylinder 13 wherein is housed a piston 14 equipped with sealing elements 15 on its periphery.

The piston 14 is connected to an inclined plate 16 connected in rotation to a shaft, so as to define a top dead center and a bottom dead center for the piston depending on the rotation of the shaft and of the inclined plate 16, corresponding respectively to the position wherein it is most retracted in its housing 13, and to the position wherein it extends most from its housing 13.

An internal volume of the expansion zone 11, which varies depending on the position of the piston 14, is defined. This internal volume is at its minimum value when the piston 14 is at the top dead center, and at its maximum value when the piston 14 is at the bottom dead center.

The intake device is configured so that the working fluid under pressure and in the gaseous state is injected when the piston 14 is substantially at its top dead center.

The volume of the expansion zone 11 is then at its minimum. The expansion of the working fluid in the gaseous state causes an increase in the volume of the expansion zone 11 and therefore a displacement of the piston 14 which causes rotation of the inclined plate 16 until the piston 14 reaches its bottom dead center.

Once the bottom dead center is reached, the working fluid in the gaseous state and now at low pressure is exhausted by means of ports 12 provided in the expansion zone 11 and connected to a discharge duct 21, these ports 12 being advantageously accessible only when the piston 14 is at the bottom dead center.

In the embodiment shown, the inclined plate 16 is connected to the piston 14 so as to form a swash plate. This connection makes it possible to transform the alternating translation movement of the piston 14 into a rotary movement of the inclined plate 16 and therefore of the shaft 42 which is connected with it.

This swash plate is positioned in the crankcase 17 of the expander 4, comprising liquid lubricant so as to ensure lubrication of the connection between the piston 14 and the inclined plate 16, and also the lubrication of the mechanical bearings allowing rotation of the shaft and the inclined plate 16.

A volume of liquid lubricant is located in the bottom of the crankcase 17, which makes it possible to ensure continuous lubrication by oil circulation by means of a pump which supplies the mechanical zones to be lubricated; the oil then falls by gravity into the bottom of the crankcase 17, then is re-injected by the pump.

Leaks of working fluid vapor into the crankcase 17, and conversely leaks of lubricant into the expansion zone 11 or the exhaust zone located downstream of the ports 12 do occur.

In order to address the problem resulting from such leaks, the crankcase 17 is equipped with an evacuation opening 18 allowing the working fluid vapor present in the crankcase 17 to circulate from the crankcase 17 toward the exhaust openings 41 by balancing the pressures between these two zones thanks to the evacuation opening 18. This opening, as well as keeping the oil at a temperature greater than the condensation temperature of the working fluid, thus avoid an accumulation of working fluid vapor in the crankcase, its condensation in the lubricant and the previously mentioned problems resulting from it. The evacuation opening 18 can be formed by drilling into the crankcase 17.

In the embodiment illustrated in FIG. 3, the pistons are crosshead pistons. Each side of the piston 14 comprises a head 14a having the general shape of a thin disk, the body 14b of the piston 14 being a rod having a diameter less than that of the head. Said rod is guided in translation by a guide 19 located in a wall of the crankcase 17. Guiding the rod of the piston being achieved over a smaller diameter makes it possible to limit the quantity of lubricant leaking from the crankcase compared to a trunk piston, for example. Possible lubricant leaks from the crankcase 17 through the rod guides 19 lead into the discharge duct 21. This duct is provided, at a low point, with a channel 20 for recovering lubricant toward the bottom of the crankcase 17. A portion of the lubricant which has leaked will be directly collected in the discharge duct 21, a portion will be carried by the exhaust vapor. Crosshead pistons are therefore preferred for this reason, but a person skilled in the art will be able to employ other types of piston without, however, departing from the scope of the present invention. Crosshead pistons thus do not have the benefit of ample lubrication and are advantageously equipped with sealing means 15 in the form of segments made of ceramics or polymers.

Moreover, to allow the lubricant having leaked from the crankcase to be separated from the expanded working fluid, the expander comprises a cavity 43 in fluid connection with the exhaust ports and leading into the exhaust openings 41. The cavity 43 extends advantageously over the length of the machine.

Operating conditions of the machine are selected so that the expanded working fluid F flows in this cavity 43, containing a gaseous portion (mainly consisting of the working fluid) and a liquid portion (mainly consisting of the lubricant L). When the working fluid is ethanol, the ethanol vapor leaving the exhaust ports is typically at a pressure of 2.2 bars and at a temperature of 115° C. Under these conditions, the ethanol vapor is said to be superheated and has no liquid droplets of ethanol. The lubricant, for its part, circulates at a temperature of 130° C. In this manner, the ethanol vapor does not condense from contact with the lubricant. The operating conditions imposed maintain the exhaust vapor in a superheated state and the lubricant at a temperature greater than the saturation temperature of the vapor at the pressure considered.

The cavity 43 is configured so as to separate the lubricant from the flow of vapor by taking advantage of the difference in density between the gaseous working fluid and the liquid lubricant.

The cavity 43 can comprise mechanical separation means making it possible to separate the liquid phase from the gaseous phase. Among these separation means, can be cited cyclone systems where, the entering flow arriving tangentially at the wall of the cavity, a vortex is created which centrifuges the liquid particles, whose density is greater than the vapor. According to a similar principle, systems with helixes can be cited which impose on the flow a vortex movement by changing the direction of the flow.

It is also possible to cite systems using baffles or deflectors, which impose one or more changes in direction on the flow. The liquid particles having a greater density, the inertia is greater and they are less suited to abrupt changes in direction; these particles then strike the walls and are flushed from them.

Coalescer systems represent yet another possibility in terms of separation. They consist of a porous filter through which the flow passes. The largest liquid droplets strike the input of the filter, the finest droplets enter into the filter with the vapor, which flows through a tortuous path. The finest droplets finally impact the filter. As the lubricant droplets accumulate in the filter, they fuse together, then detach and fall by gravity.

The cavity 43 is located in a zone of the expander 4 above the liquid level of the oil in the crankcase 17, so that the separated liquid portion flows toward the upstream of the flow. An opening 44 is advantageously positioned in a low point of the cavity 43 to allow the return of the lubricant L to the crankcase 17.

Moreover, the flow area of the cavity 43 is advantageously as large as possible so as to reduce the flow speed for a given flow rate of exhaust vapor.

Advantageously, the cavity 43 is formed so that the path length of the working fluid in the cavity is as long as possible, so as on the one hand to be able to insert more effective mechanical separation means and, on the other hand, to increase the transit time of the flow in said separation cavity.

A person skilled in the art can employ any known separation means, possibly by combining several means, depending on the separation quality expected.

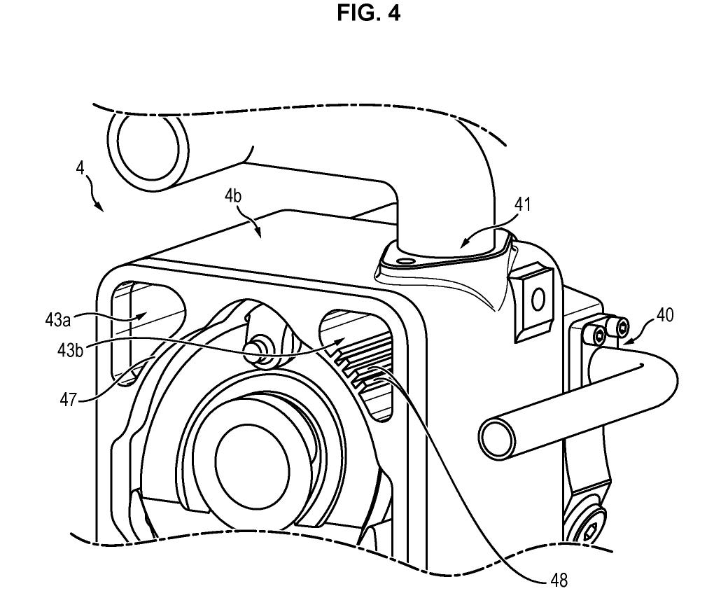

Moreover, as illustrated in FIG. 4, the separation can be improved by dividing the cavity 43 into two distinct chambers 43a, 43b each positioned along the length of the machine 4. Compared to a single cavity, the two chambers offer increased space for inserting mechanical separation means, and a larger flow area, and therefore a greater slowing effect.

According to one embodiment, these two chambers can be connected to the two expansion zones of the machine, each chamber leading into a respective exhaust opening.

According to one preferred embodiment, each chamber is connected to a respective expansion zone and to a respective exhaust opening. In this case, it is advantageously arranged that the openings are located in the vicinity of each end of the machine and that each chamber is connected to the ports of the expansion zone located on the side opposite the exhaust port. Thus, the length traveled by the expanded working fluid is maximized, as shown schematically by the arrows in FIG. 2.

According to one embodiment, the separation is accomplished or assisted by the presence of a metal coalescing filter 45 (see FIG. 3). Advantageously, this filter 45, the cavity 43 and the crankcase 17 consist of a single part, made by casting. The coalescing filter is thus metal foam integrated in the structure.

According to one embodiment, the separation is accomplished or assisted by the presence of a vortex. This vortex can be created by flow entering tangentially to the wall of the cavity (cyclone) or by the position of a helical part 46 positioned at the entrance of the cavity (see FIG. 3).

According to one embodiment, the separation is accomplished or assisted by the presence of deflectors (not shown) which change the trajectory of the vapor flow and collect the lubricant droplets which impact on them.

Another effect of the cavity 43 is that this cavity having a common wall 47 with the crankcase 17 and surrounding at least one portion of the crankcase, the expanded working fluid circulating in the cavity makes it possible to cool the oil contained in the crankcase 17 by heat exchange through this wall 47. For example, when the working fluid is ethanol, its temperature in the expanded state during its passage through the cavity is on the order of 115° C. The lubricant present in the crankcase is, for its part likely to rise to a temperature of 140° C. in particular due to friction, but the wall 47 thermostatically controlled by the ethanol vapor makes it possible to reduce this temperature.

This cooling effect increases as the surface of the common wall 47 increases. Consequently, the embodiment wherein, as in FIG. 4, the cavity 43 is divided into two distinct chambers 43a, 43b, is also advantageous from this point of view.

The cooling effect can possibly be further reinforced by positioning supplementary cooling means in the cavity.

For example, these supplementary means can comprise fins 48 (see FIG. 4) extending from the common wall with the crankcase, which increase the heat exchange surface area.

These supplementary means can perform both a separation function and a cooling function. Baffles can also function as cooling fins; likewise, a metal coalescing filter develops a considerable heat exchange surface area.

The expander 4 can be realized as two half-shells 4a, 4b connected along a plane P transverse to the machine, each half-shell comprising one intake zone 40 and one exhaust opening 41.

In other words, the cavity described above therefore constitutes a separation member integrated with the machine.

It is therefore not necessary, in the thermal energy conversion system, to provide a distinct separation member.

Thus, the compactness of the thermal energy conversion system is preserved.

On the other hand, the fact that the separation is integrated into the expander also makes it possible to reduce the cost of the system.

Finally, this arrangement makes it possible to cool the lubricant and to preserve its integrity as well as guaranteeing operation at a known and continuous viscosity.

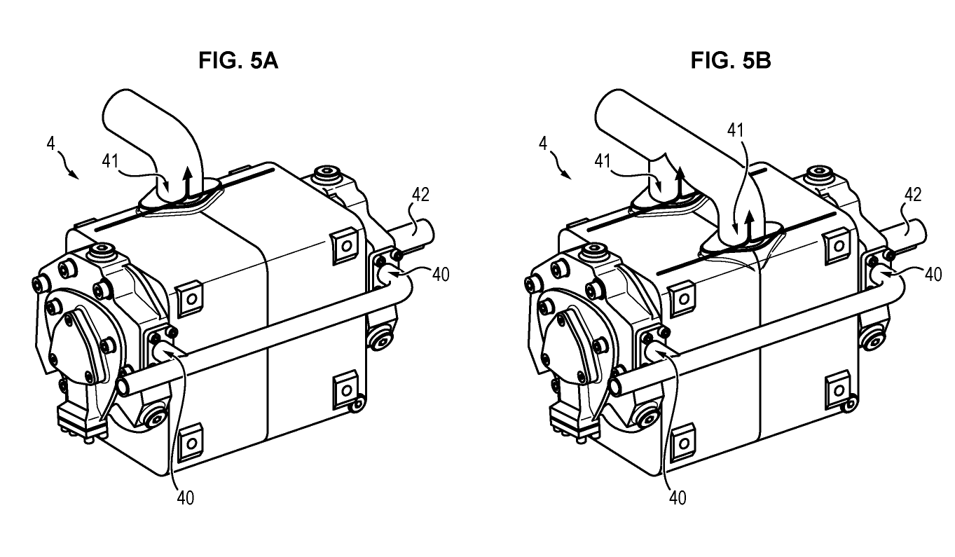

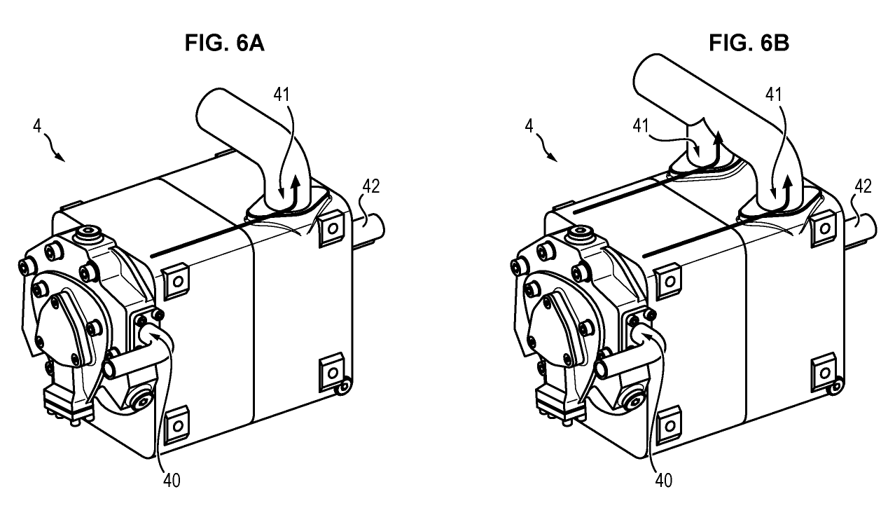

FIGS. 5A to 6B illustrate other embodiments of an axial expander according to the invention. The arrows show the flow in the cavity toward the exhaust opening(s). Regardless of the number of intake or exhaust openings, the machine can be made of two half-shells along a transverse plane.

FIGS. 5A and 5B illustrate two other embodiments of an axial expander comprising double-action pistons.

In such a machine, there are two intake openings 40 for working fluid under pressure, located at the two opposite ends of the machine.

In the case of FIG. 5A, there is a single exhaust opening 41 located substantially in a central portion of the machine. The cavity 43 (not shown) extends between the exhaust ports of the two expansion zones located at each end of the machine and the exhaust opening 41. The distance through which the working fluid travels is therefore substantially the same no matter which expansion zone it is coming from.

In the case of FIG. 5B, there exist two exhaust openings 41 located substantially in a central portion of the machine. The cavity is divided into two longitudinal chambers extending between the exhaust ports of the two expansion zones located at each end of the machine, and each leading into a respective exhaust opening 41.

FIGS. 6A and 6B illustrate two embodiments of an axial expander comprising single-acting pistons.

In such a machine, there exists a single intake opening 40 for working fluid under pressure, located at a first end of the machine.

In the case of FIG. 6A, there exists a single exhaust opening 41, located preferably on the second end of the machine, opposite to the first. The cavity 43 (not shown) extends between the exhaust ports of the expansion zone located toward the first end and the exhaust opening located at the second end.

In the case of FIG. 6B, there exist two exhaust openings 41, both of them located at the second end of the machine. The cavity is divided into two longitudinal chambers each leading into an exhaust opening 41.

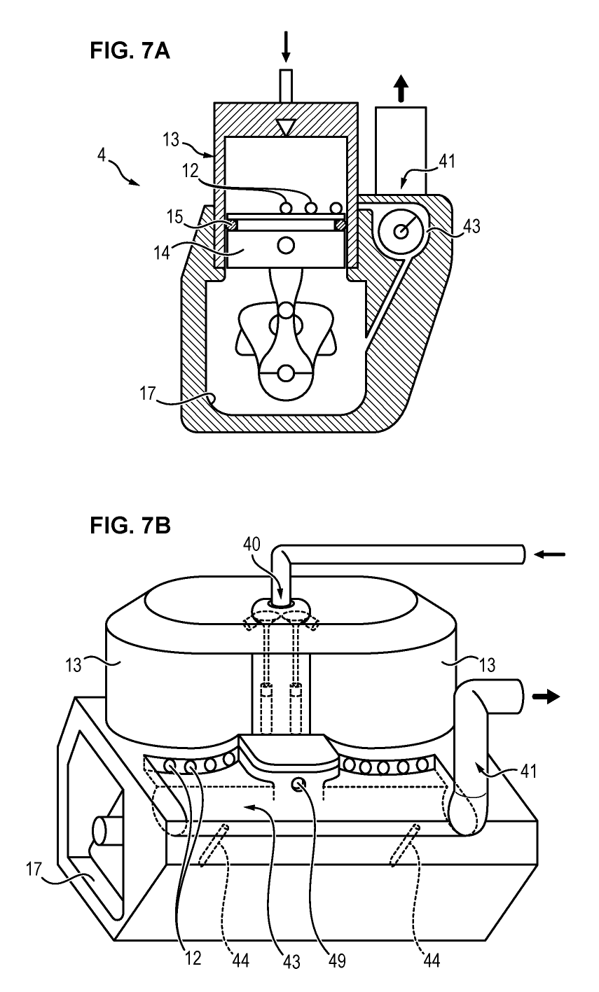

According to another embodiment, illustrated in FIGS. 7A and 7B, the expander 4 has an architecture with two in-line cylinders, the pistons being connected to the engine shaft by a conventional connecting rod-crankshaft connection. Said connection is contained in a crankcase 17 containing the lubricant in the liquid state. The separation cavity 43 is organized along the length of the expander, i.e. parallel to the axis of the crankshaft. This cavity 43 is connected to the exhaust ports 12 and leads to a high point of the machine, at the exhaust opening 41 of the machine.

The cavity 43 can comprise mechanical separation means (not shown) such as deflectors, baffles or a Venturi effect helix.

Channels 44 make it possible for the lubricant deposited on the walls of said cavity and accumulating by gravity in a low point to flow away toward the oil sump.

A channel 49 is moreover provided between the crankcase 17 of the crankshaft and the separation cavity 43, allowing balancing of pressures in these two zones and allowing the vapor of the working fluid to flow toward the exhaust opening, thus avoiding its accumulation in the crankcase.

1. A piston type expander comprising:
an intake cylinder head for a working fluid in the gaseous state under pressure comprising an intake opening for said working fluid,
an expansion zone connected to the intake cylinder head and comprising a plurality of cylinders, wherein a piston sliding in each respective cylinder is connected to a shaft by a mechanical connection, each cylinder comprising at least one exhaust port through which the expanded working fluid in the gaseous state can be exhausted from the expansion zone,
a crankcase designed to contain a lubricant in the liquid state, in which is positioned said mechanical connection,
a cavity provided in the expander, connected to said exhaust ports, leading to an exhaust opening of the expander for the expanded working fluid in the gaseous state, said cavity being designed to guide a flow of the expanded working fluid bearing a fraction of lubricant in the liquid state, said cavity having a common wall with the crankcase and being designed to favor the separation of the liquid lubricant fraction from the expanded working fluid in the gaseous state.

2. The expander according to claim 1, wherein the cavity comprises mechanical means for separating the lubricant in the liquid state from the working fluid in the gaseous state.

3. The expander according to claim 2, wherein the separation means comprise at least one of: a system designed to cause rotation and/or turbulence in the flow, a coalescer, a deflector and a baffle.

4. The expander according to claim 3, wherein said mechanical separation means comprise a coalescer forming an integral part of the cavity.

5. The expander according to claim 1, wherein the cavity is formed so as to slow down the flow of the expanded working fluid in the gaseous state.

6. The expander according to claim 1, wherein the cavity is divided longitudinally into two distinct chambers.

7. The expander according to claim 1, wherein the cavity comprises means for cooling the common wall with the crankcase.

8. The expander according to claim 7, wherein said cooling means comprise fins extending into the cavity from the common wall with the crankcase.

9. The expander according to claim 1, wherein said expander is axial, the mechanical connection between each piston and the shaft comprising an inclined plate, each piston being parallel to said shaft.

10. The expander according to claim 9, wherein the pistons are double-acting, the expander comprising two expansion zones on either side of the expander and a single exhaust opening for the expanded working fluid and in that the cavity is connected to the exhaust ports of the two expansion zones and to the exhaust opening.

11. The expander according to claim 9, wherein the pistons are double-acting, the expander comprising two expansion zones on either side of the expander and two exhaust openings for the expanded working fluid, and in that the cavity is divided longitudinally into two distinct chambers, each chamber is connected to both expansion zones and to an exhaust opening.

12. The expander according to claim 9, wherein the pistons are double-acting, the expander comprises two expansion zones on either side of the expander and two exhaust openings for the expanded working fluid, and in that the cavity is divided longitudinally into two distinct chambers, each chamber is connected to the exhaust ports of a respective expansion zone and to the exhaust opening opposite to said expansion zone.

13. The expander according to claim 1, wherein the pistons are crosshead pistons, each crosshead being guided by a guide provided in a wall of the crankcase forming a partition between the exhaust zone and the crankcase.

14. The expander according to claim 1, wherein the cavity comprises at least one opening designed to allow return of the lubricant in the liquid state to the crankcase.

15. The expander according to claim 1, wherein the crankcase comprises an evacuation opening for the working fluid in the gaseous state toward the exhaust opening.

16. A system for converting thermal energy from a combustion engine comprising an expander according to claim 1 and a single device for separating lubricant from the working fluid, said device being positioned in the cavity of the expander.

17. A method for separating a fraction of lubricant in the liquid state from a working fluid in the gaseous state in a piston type expander, comprising:
intake of the working fluid in the gaseous state under pressure in an intake cylinder head through an intake opening,
expansion of said working fluid in the gaseous state in an expansion zone connected to the intake cylinder head and comprising a plurality of cylinders, wherein a piston sliding in each respective cylinder is connected to a shaft by a mechanical connection lubricated by the lubricant in the liquid state,
discharge of the expanded working fluid in the gaseous state through at least one exhaust port provided in each cylinder,
flow, in a cavity provided in the expander, connected to said exhaust ports and leading to an exhaust opening of the expander for the expanded working fluid in the gaseous state, of a flow of the expanded working fluid bearing a fraction of lubricant in the liquid state, and separation, in said cavity, of the liquid lubricant fraction from the expanded working fluid in the gaseous state.
